(19) United States
(12) Patent Application Publication
(10) Pub. No.: US 2002/0092132 A1
(43) Pub. Date: Jul. 18, 2002

(54) Protective sleeve for shopping cart handles

(76) Inventor: Patricia C. Kessler, Batavia, IL (US)

Correspondence Address: Lisa C. Childs, LAFF, WHITESEL & SARET, LTD., 401 N. Michigan Ave., Suite 1700, Chicago, IL, 60611, US

(21) Appl. No.: 09/761,996

(22) Filed: Jan. 17, 2001

(51) Int. Cl. B62B 1/00

(52) U.S. Cl. 16/436

(57) ABSTRACT

The present invention is comprised of a semi-rigid protective sleeve for a substantially cylindrical handle of a shopping cart. The sleeve is made up of a thin sheet of material, preferably anti-bacterial polypropylene, of sufficient size to surround the handle. The sleeve has a first and second longitudinal edge to releasably conform to the handle. The edges are preferably notched to accommodate any protrusions of the handle. The sleeve is suitable for use as an advertising vehicle.

This invention relates to shopping cart handles, and, in particular, a device for protecting users and child riders of shopping carts from unsanitary shopping cart handles.

### BACKGROUND OF THE INVENTION

There are various known ways for protecting users of shopping carts from unsanitary cart handles, including washing the handle between uses, wearing gloves, or installing a product sold under the name Cart Caddy, which appears to be made of a fabric material that is wrapped over and hangs from a shopping cart handle with pockets for carrying pens, calculators, coupons, cash and the like, but they all suffer from being inconvenient, awkward, and expensive. For example, washing the handle between uses is time consuming and takes the cart out of use for a time. The fabric product is expensive and difficult to clean. Wearing gloves protects only the user, not any children who may be riding in the cart's basket and chewing on the handle.

Consequently, a need exists for, and it is an object of this invention to provide, a convenient and inexpensive way of protecting shopping cart users and riders from the unsanitary conditions of such carts.

### SUMMARY OF THE INVENTION

The present invention is comprised of a semi-rigid protective sleeve for the typical, substantially cylindrical handle of a shopping cart. The sleeve is made up of a thin sheet of material, preferably anti-microbial polypropylene, of sufficient size to substantially surround the handle. The sleeve has first and second longitudinal edges to permit easy installation on and removal from the handle. The edges are preferably notched to accommodate baskets or other wire pieces commonly attached to the handle. The sleeve is also suitable for displaying advertising.

### BRIEF DESCRIPTION OF THE DRAWINGS

FIG. 1 is a perspective view of the inventive sleeve in place on a handle of a shopping cart.

FIG. 2 is a cross-section of the sleeve and cart handle.

FIG. 3 is a perspective view of the inventive sleeve.

FIG. 4 is a perspective view of the inventive sleeve in place on a different shopping cart handle attached to a basket.

FIG. 5 is a cut-away view showing how the inventive sleeve fits around the handle and projecting basket seen in FIG. 4.

### DETAILED DESCRIPTION OF THE INVENTION

The present invention involves a semi-rigid protective sleeve for a substantially cylindrical handle of a shopping cart to protect the user of the cart from germs left by previous users. The sleeve is composed of a thin sheet of resilient material, preferably anti-microbial polypropylene, formed generally in a tubular or open-ended cylindrical shape and of sufficient diameter to substantially surround the handle. The sleeve has first and second longitudinal edges to releasably conform to the handle. The edges are preferably notched to accommodate any protrusions of the handle.

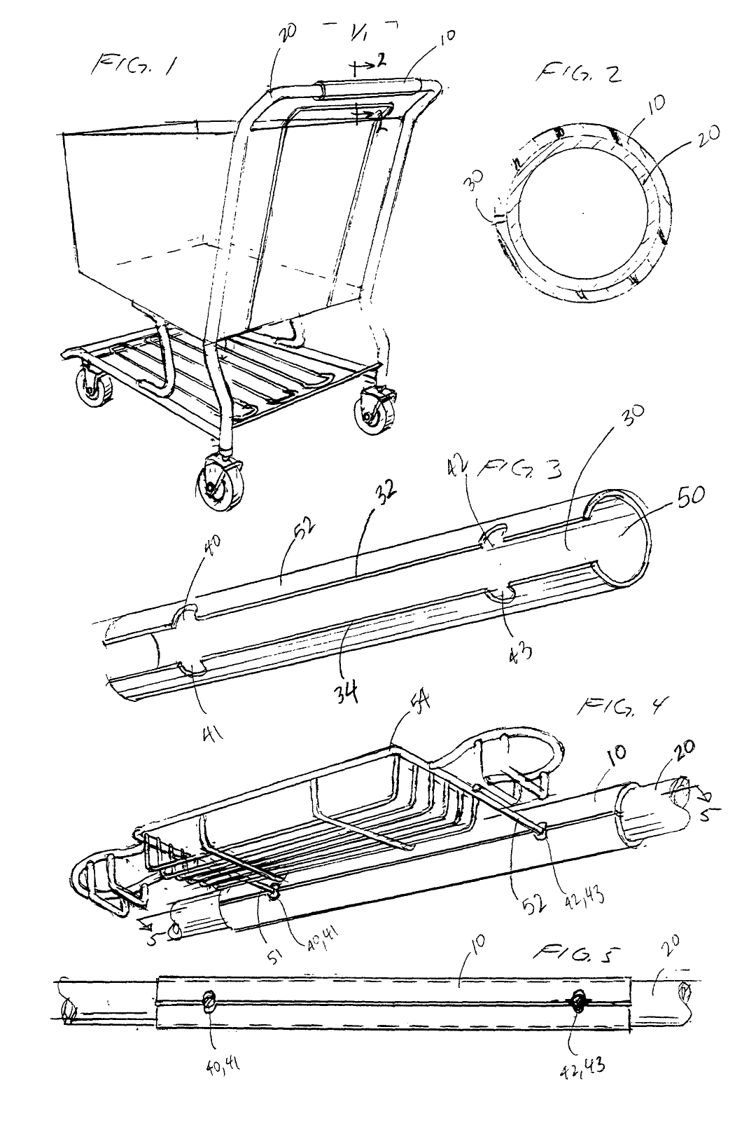

As seen in FIG. 1, the protective sleeve 10 fits on the shopping cart handle 20. As seen in FIG. 2, the sleeve 10 envelopes the handle 20. As seen in FIGS. 2 and 3, the sleeve is slit so that first longitudinal edge 32 and second longitudinal edge 34 extend parallel to each other and are separated by gap 30. To install the sleeve 10 on handle 20, the edges 32, 34 are spread apart, and then the resiliency of the sleeve causes it to snap-fit onto the handle 20. As further seen in FIG. 3, the sleeve preferably includes a plurality of notches 40, 41, 42 and 43 extending from edges 32, 34 away from gap 30. The notches are designed to receive the wires 50 and 52 of the tray 54 attached to the handle 20 of some carts. As seen in FIG. 5, the presence of the notches 40, 41, 42 and 43 does not interfere with the sleeve's ability to flexibly fit onto the handle even when the tray is not present.

Preferably, the sleeve 10 is made of polypropylene sufficiently thin so that it flexibly enfolds the handle. A preferred thickness is that of a drinking straw. One suitable anti-microbial polypropylene is sold by Clariant (Winchester Va.) under the brand name Sanitized® MBP-9661. The manufacturer describes Sanitized® MBP-9661 as an antibacterial masterbatch pre-dispersed in polypropylene resin carrier. The active ingredient is Sanitized®PLA, a halogenated phenoxy compound registered by EPA under Registration Number 3090-215. More specifically, the active ingredient is 5-chloro-2-(2, 4-dichlorophenoxy)phenol. Sanitized® MBP-9661 is described by the manufacturer as a bacteriostatic agent that is effective against non-health related organisms that protect the article itself against growth of bacteria and mold in or on the treated article.

In a preferred embodiment, the sleeve 20 has an inner surface 50 and an outer surface 52. The inner surface 50 generally surrounds and substantially contacts the handle 20. The outer surface 52 is suitable for carrying advertisements and is the surface the child rider and user contact. Because the sleeve generally surrounds and conforms to the handle, the hands of the cart's user grip and encircle the handle, so that the experience of propelling the cart with the sleeve in place is essentially identical to the non-sleeve experience, except that the sleeve experience is less germ-ridden.

The sleeve 20 thus is made of a non-toxic, inexpensive plastic. The sleeve 20 is suitable for having advertisements embossed, printed thereon, or otherwise applied. The sleeves may be dispensed much as drinking straws are dispensed, either individually wrapped, or singly and unwrapped from a dispenser. In either case, the sleeve can be sanitized, either by the manufacturer or the store owner, or the user can at least wipe clean the sleeve with a paper towel or tissue prior to use. The cart's user takes the sleeve and snap-fits it onto the cart's handle, enveloping the handle and shielding the user from previous user's germs and diseases. Children riding in the car who usually chew on the cart handle will instead chew on the sleeve, which has been sanitized or wiped clean. Because the sleeve has notches, it can be used for virtually any cart, including those on which trays have been added for the carrying of wallets, lists, and the like. Because the sleeve is inexpensive, it can preferably be used once and then disposed of.

It should be recognized that, while the invention has been described in relation to a preferred embodiment, those skilled in the art may develop a wide variation of structural details without departing from the principles of the invention. Accordingly, the appended claims are to be construed to cover all equivalents falling within the scope and spirit of the invention.

The invention claimed is:

1. A protective sleeve for a substantially cylindrical cart handle comprising: a tube of sufficient size to substantially surround the handle, the tube having first and second longitudinal edges.

2. The sleeve of claim 1 wherein the tube releasably conforms to the handle.

3. The sleeve of claim 1 wherein the tube is polypropylene.

4. The sleeve of claim 3 wherein the tube is anti-microbial polypropylene.

5. The sleeve of claim 1 wherein the longitudinal edges are notched to accommodate any protrusions on the handle.

6. The sleeve of claim 1 wherein the sleeve has advertisements thereon.

7. A protective sleeve for a substantially cylindrical cart handle comprising: a cylindrical sheet of resilient material of sufficient size to substantially surround and releasably conform to the handle, the sheet having first and second longitudinal edges.

8. The sleeve of claim 7 wherein the material is polypropylene.

9. The sleeve of claim 8 wherein the material is anti-microbial polypropylene.

10. The sleeve of claim 7 wherein the sheet snap-fits around the handle.

11. The sleeve of claim 7 wherein the longitudinal edges are notched.

12. The sleeve of claim 7 wherein the sheet displays advertisements.

13. A semi-rigid protective sleeve for a substantially cylindrical cart handle comprising a tube of anti-microbial polypropylene material of sufficient size to surround the handle, the tube having first and second longitudinal edges to snap-fit around the handle, and the tube being sized to generally conform to the handle.

14. The sleeve of claim 13 wherein said sleeve displays advertisements.

15. The sleeve of claim 13 wherein said handle is a shopping cart handle.

16. The sleeve of claim 13 wherein said longitudinal edges are spaced apart.
